(19) United States
(12) Patent Application Publication
(10) Pub. No.: US 2003/0203091 A1
(43) Pub. Date: Oct. 30, 2003

(54) Dough product treatment process and products thereof

(76) Inventor: Susan M. Hayes-Jacobson, Minneapolis, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/132,655

(22) Filed: Apr. 24, 2002

(51) Int. Cl. A21D 10/00

(52) U.S. Cl. 426/549

(57) ABSTRACT

A process comprises the steps, in order, of preparing a unbaked dough having a surface consistency such that the unbaked dough is processable in automated dough processing equipment; forming a dough product from the unbaked dough; baking the formed dough product; treating the baked dough product by applying a fat composition thereto under conditions to allow absorption of a sufficient amount of the fat into the dough to noticeably improve textural properties of the baked dough product after microwave reheating as compared to a like product without fat absorbed therein; and storing the treated baked dough product in a frozen state. Products and methods of preparing said products for consumption are also provided.

### FIELD OF THE INVENTION

The present invention relates to dough products. More specifically, the present invention relates to dough products that are formed and baked, with subsequent surface modification prior to frozen storage to provide a tender or soft baked dough product.

### BACKGROUND OF THE INVENTION

Various glazings and coatings have been applied to bakery products for many years to modify the surface appearance of these products. For example, U.S. Pat. No. 4,038,422 to Keyser et al. describes a coating for baked products, wherein the amount of fat from the coating which is absorbed by the dough portion of the baked product is significantly reduced without reducing the fat content of the coating. The coating contains specified amounts of vegetable oil or fats, sugar, and nonfat dry milk solids. The coating as described in this patent cannot have less than 25% of nonfat dry milk solids in the coating, or fats will bleed into the baked product—an undesired result in the described product. This coating is applied after the product is baked. Products having a significant amount of fat absorbed into the dough were found to be unacceptable. The coating may contain heat sensitive vitamins. The specification specifically points out that the coating should not be heated to a temperature that would cause degradation of the most heat sensitive ingredients therein. See column 4, lines 45-49. Additionally, when heat sensitive vitamins are used, is noted that a benefit is to allow provision of a product that has a high level of heat sensitive vitamins because the coating is not baked after application of this coating. See column 1, lines 20-25.

A food glaze composition is described in U.S. Pat. No. 5,976,586 to Feller, that includes one or more natural or modified vegetable gums and that is eggless and protein-free. This glaze composition is applied to food products before and/or after baking and freezing, and is applied to provide an even color and uniform shine to the bakery product. See column 1, lines 54-56. There is no disclosure of incorporation of oil into the glaze as described in this patent.

U.S. Pat. No. 4,762,721 to Holscher describes a glazing agent characterized in that consists of homogenized emulsion of a protein, an edible oil, water and a thin-boiling starch. The glazing as described therein is applied prior to baking. See column 3, lines 30-36.

U.S. Pat. No. 5,130,150 to Averbach discloses a thin, edible moisture barrier consisting essentially of oleaginous material (oils and fats) and wax. This moisture barrier is applied to food product that may be baked, such as by baking, frying or boiling, or fresh. Baked products include baked goods, and fresh products include fruits and vegetables. See column 3, lines 15-26. The barriers as described therein are extremely thin and essentially imperceptible to taste, and are also impermeable to the migration of water or of water vapor through them. See column 4, lines 59-64. This reference does not disclose subsequent processing of the food, either by freezing or reheating.

U.S. Pat. No. 5,576,036 to Pesheck, et al. discloses a pre-baked microwavable dough composition comprising a microwavable dough and a crisping agent. The crisping patient is applied to the dough prior to the pre-baking step. See column 4, lines 45-47. The crisping agent comprises particles, such as nuts, grains, seeds and bread crumbs. See column 5, lines 5-9. The crisping agent is affixed to the dough by any number of means, including aqueous based starch slurries, egg albumen, a solution of sugar, etc. See column 5, lines 10-13. Oils and fats may also be used, as discussed at column 5, lines 37.

In the effort to provide dough-handling equipment that will form dough products in a faster and more efficient manner, certain equipment modifications have been proposed to address issues raised in high-speed dough manipulation. U.S. Pat. No. 5,110,610 to Cummins discloses a dough piece rounder and method where the belt used for conveying the dough pieces past the rounder bar is supported by a thin film of air between the underside of the conveyor belt and a perforated plate which forms the upper flat side of a plenum chamber. The principal part of the apparatus is supported on a horizontal cantilever cylinder so that the belt can be readily replaced from one side and the apparatus can be tilted so that the inlet and exit of the dough pieces can be at different levels. The object of the invention described therein is to accommodate the higher speeds of production of buns and rolls by reducing the heat buildup of the rounder and form a better seal between rounder bar and conveyor belt. This in turn will increase efficiencies and make the state of the art of the rounder device and method comparable to the speed capabilities of the state of the art dividers.

Means and methods for controlling toughening and firming in microwaved dough-based and batter-based products are described in U.S. Pat. No. 5,035,904, wherein a dough is formed comprising water, flour and a texturizing agent selected from the group consisting of surfactants, hydrogen bond-breakers, fast acting oxidants, enzymes, and disulfide-reactants. The texturizing agent is included in an amount sufficient to provide a degree of toughening of the edible product when subjected to microwave irradiation which is distinguishably less than the degree of toughening generated from a dough which is formed without the texturizing agent.

### SUMMARY OF THE INVENTION

The present invention provides a process for efficiently producing a frozen baked dough product, which after reheating in a microwave is a tender or soft baked dough product. The process comprises the steps, in order, of preparing a unbaked dough having a surface consistency such that the unbaked dough is processable in automated dough processing equipment; forming a dough product from the unbaked dough; baking the formed dough product; treating the baked dough product by applying a fat composition thereto under conditions to allow absorption of a sufficient amount of the fat into the dough to noticeably improve textural properties of the baked dough product after microwave reheating as compared to a like product without fat absorbed therein; and storing the treated baked dough product in a frozen state.

Products and methods of preparing said products for consumption are also provided.

### BRIEF DESCRIPTION OF THE DRAWING

FIG. 1 is a chart showing assessment of the textural attributes of products by a team panel.

FIG. 2 is a chart showing the Microwaved Product Modulus Evaluation for products evaluated immediately after microwave heating.

FIG. 3 is a chart showing the Microwaved Product Modulus Evaluation for products evaluated 15 minutes after microwave heating.

### DETAILED DESCRIPTION OF THE INVENTION

Dough based products that are both conveniently stored and easy to prepare are desired in the marketplace. The cost of such products is dramatically reduced when they are prepared by mass production methods. To be processed in a rapid manner, dough products must be easily handled by the machinery that forms the dough product from the bulk dough and conveys the individual products to ovens for baking. Such machinery includes elements that will convey the dough, such as shuttles, conveyor belts, feeders, and the like; and elements that will manipulate the shape of the dough, such as compressor rolls, compression belts, sheeters, cutting devices, dividers, and the like. Highest efficiencies are obtained when the dough product is conveyed by direct contact with conveyor belts, so that the dough product is not contained in a pan or container in the manufacturing process. It has been found that certain dough characteristics are required for efficient handling by such machinery. An unbaked dough that is too sticky or soft will become entangled in, stick to, or jam machinery, and will otherwise be impossible to rapidly process through the machinery. This is a particular problem with conveying of unbaked dough products without a pan. For purposes of the present invention, “unbaked dough” refers to dough prior to entrance in the oven for total baking of the dough product. Thus, even if the bottom of a dough product is treated, such as by heating or application of a non-stick ingredient to the product, if the dough product has a soft consistency at the time of conveyance the product may droop over the edges of initial contact and stick to the conveyor belt, causing processing difficulties.

While one possible solution to the conveyance problem discussed above is to change the surface characteristics of the uncooked dough product, this change will have other consequences as well. As a general proposition, the surface characteristics of the unbaked dough prior to being baked will dictate the textural characteristics of the final baked product. Thus, a unbaked dough that is firm and dry in surface characteristics is expected to result in a baked product that is also firm and dry, or even crusty or hard. It thus appeared to be inevitable that when unbaked dough possesses the characteristics required for rapid machine forming and conveying without a pan, the resulting final baked product necessarily is firm, and cannot be soft or tender, especially after microwaving.

Surprisingly, it has been found that it is possible to provide a dough product that is both readily processable by high-speed dough processing equipment, and also is tender in texture after being baked, stored in the frozen state, and microwave heated. This end product texture has been surprisingly obtained by the process as described above, wherein a baked dough product is treated by application of a fat composition to the baked dough product prior to freezing in a manner as described herein.

The treated baked dough product of the present invention has noticeably improved textural properties of the baked dough product after microwave reheating as compared to a like product without fat absorbed therein. More specifically, the treated product as described herein is noticeably more tender in texture as compared to a like product that does not have fat absorbed therein. The advantage provided to the product can be evaluated both by sensory evaluation using trained test panels and by physical measurement of the properties of the product using measuring devices, as described below. For purposes of this disclosure, a “like product” is a product that has substantially the same formula except for the added fat as hereinafter described. Such a “like product” is also analogously processed i.e., it is processed in the same way with the exception of the added fat, and prebaked in the same way.

The frozen baked dough product of the present invention is designed for reheating by microwave oven. Microwave oven reheating presents particular challenges to the texture of bread products, because it tends to harden or toughen the bread products. This is particularly the case when the product has been resting on the plate for 5 to 15 minutes after microwave heating. Because reheating by a microwave oven provides the highest degree of convenience to the consumer, this technique of heating is often used by consumers in a hurry, even though the resulting product may have a less than satisfactory texture. If the texture resulting from microwave reheating of certain products is poor, that customer may be discouraged from purchasing those products in the future.

It has been found that products of the present invention also surprisingly exhibit a time advantage in reheating in the microwave as compared to products that did not contained fat as described herein. Thus, surprisingly the core temperature of the product of the present invention was found to be higher at the end of the 30 second microwave time than the core temperature of a non-fat containing product. This is the case even though the fat appears only on the surface or just below the surface of the product, rather than in the core of the product.

As discussed in more detail below, the fat composition of the present invention may contain additional ingredients, such as flavorants and the like. Because the fat composition is not applied until after baking, substantial benefits may be realized in being able to provide such additional ingredients to the baked dough product without having them exposed to oven baking conditions. Thus, temperature sensitive ingredients, relatively volatile ingredients, or extremely fragrant ingredients may be conveniently provided on the baked dough product. A particular example of this benefit is in application of garlic to the baked dough product in the fat composition as described herein. Because the garlic does not go through the oven in the product preparation process, garlic aroma in the manufacturing facility is substantially reduced as compared to conventional processes.

In the method of the present invention, the dough is first prepared to have a surface consistency such that the unbaked dough is conveyable without a pan in automated dough processing equipment during and after proofing. A dough is considered to have a consistency that is not conveyable if it sticks to a mesh tray under temperature and humidity conditions of operation of the processing equipment. This evaluation is carried out on a mesh material made from 17 gauge T305 stainless steel, having a pitch of about 60 wires per foot in the x axis direction, and a pitch of about 12 wires per foot in the y axis direction. Most preferably, the formed dough product has surface characteristics such that it will not stick to the finger after being touched by moderate finger pressure. Preferably, the dough when evaluated immediately after being mixed and prior to being surface treated or heat treated (hereinafter “raw dough”) has a farinograph reading of from about 800 to about 1000 Brabender units. More preferably the raw dough has a farinograph reading of from about 850 to about 950 Brabender units. Unless otherwise indicated, the farinograph reading is carried out using a water bath temperature of 60 F. +/−1 F., with a mixer speed of 63 rpm, and a dough sample weight of 480 grams.

After preparation of the dough, the dough product is formed to the desired shape for baking. The shape is preferably imparted by conventional mechanized dough processing equipment, such as is disclosed in U.S. Pat. Nos. 5,110,610; 5,388,390 and 5,535,575, the disclosures of which are incorporated herein by reference. Preferably, the dough processing equipment is high-speed processing equipment, meaning that the total dough piece output of the dough processing equipment from bulk unbaked dough is greater than about 500 pieces of dough per minute, and more preferably greater than about 750 pieces of dough per minute, and most preferably greater than about 1000 pieces of dough per minute. In the case of leavened dough products, the dough is preferably proofed after forming to the desired shape for baking.

The formed dough product is then baked to the desired degree of doneness required for the particular product. Although it is contemplated that the dough product of the present invention will be reheated after frozen storage, in particularly preferred embodiments the product is baked to a degree of doneness such that the product is ready to eat after being thawed from frozen storage in the event that the subsequent reheating step is not performed. In certain embodiments it may be appropriate to only partially bake the dough product, with completion of the cooking process done in the microwave oven by the consumer after removing from the freezer. For example, the product may be baked to the desired outside color, such as a golden brown for a breadstick, with the inside still requiring some degree of heating to provide the desired texture of a product to be eaten.

After baking, fat is applied to a substantial portion of the baked dough product under conditions to allow absorption of a sufficient amount of the fat into the dough to modify the texture of a substantial portion of the baked dough product. Preferably, the fat is applied only to the upper surface of the baked dough product, i.e. all surfaces of the baked dough product that is not in contact with the substrate on which the baked dough product is resting when being baked. Alternatively, fat may be applied, for example, only to the topmost surface of the baked dough product, i.e. the horizontal surface opposite to the surface that is in contact with the substrate on which the baked dough product is resting when being baked. In a less preferred embodiment, fact is applied to the entire surface of the baked dough product. This embodiments less preferred because complete coverage of the product in fat may lead to clean-up issues.

In an embodiment of the present invention, the fat to be applied is provided in a composition having a viscosity from about 1 to about 15,000 centipoise, and more preferably about 100 to about 5,000 centipoise at 195° F. Unless otherwise indicated, the viscosity measurement is carried out on a Haake VT 550 viscometer, with an MVI sensor. The viscometer is run from 100 to 300 rpms. In this embodiment, the fat is preferably applied to the baked dough product at a coating weight of from about 0.02 to about 0.06 g/in², and more preferably from about 0.03 to about 0.05 g/in². It has been found that these coating weights for this viscosity material provides the desired coverage of the product without providing so much excess fat that the fat drips off of the product, thereby causing clean-up issues. In a preferred embodiment, fat is applied in an amount such that it is substantially completely absorbed into the dough product, with only a small amount of excess fat visibly perceptible on the surface of the product. In these embodiments, the amount of fat on the surface of the baked dough product may optionally be limited. In a preferred embodiment, a thawed dough product of the present invention will contain less than about 0.02 g/in² of fat on the surface as determined by the Towel Absorbency Test, wherein the amount of oil that is on the surface of the product is determined by wiping the product without compressive force with a tared paper towel, and weighing the oil so removed and dividing by the surface area of the thawed dough product. For increased accuracy, a plurality of products may be wiped in aggregate, with the resulting weight of oil collected divided by the surface area of all of the products.

In an alternative embodiment, surface fat may be perceived to be undesirable by the consumer. For these embodiments, the product preferably has no visibly perceptible surface fat. In a particularly preferred embodiment, the thawed dough product of the present invention transfers no visible fat to a paper towel after resting on the towel for one minute.

In an alternative embodiment, the fat applied in the present invention is provided in a composition having a viscosity from about 2,000 to about 50,000, and more preferably from about 3,000 to about 20,000 centipoise at 195° F. and/or contains particulates that help retain the fat on the surface of the baked dough product. These compositions may be applied at a coating weight that is higher, and potentially much higher, than lower viscosity compositions, because higher viscosity compositions do not drip off of the baked dough product as easily. These compositions are applied under conditions wherein at least some of the fat is absorbed into the dough product in an amount effective to modify the texture of a substantial portion of the baked dough product. Preferably, the fat composition is applied at a coating weight of from about 0.3 to about 0.7 g/in². In compositions of viscosity greater than 10,000 centipoise, additional flavors are preferably added to provide a product that is more desirable for consumption by the consumer. Preferred flavorings are discussed below.

Most preferably, the fat composition is applied to the baked dough product while the product is at a temperature above about 120° F., more preferably from about 130° F. to about to 210° F., and most preferably from about 140° F. to about 200° F. In the preferred process of the present invention, the fat composition is applied shortly after completion of the baking process, without intermediate reheating of the baked dough product prior to application of the fat composition. It has surprisingly been found that the application of the fat composition to the baked dough product of the present invention while the product is still hot from the baking process substantially facilitates the absorption of the fat into the baked dough product. While not being bound by theory, it is believed that application of fat to the dough product while the product is still warm allows for imbibing of the fat through pores that are still open in the freshly baked and still hot product.

The fat composition as used in the process of the present invention is any composition comprising fats in amount sufficient to modify the texture of a substantial portion of the baked dough product. Preferably, the fat composition comprises at least about 50 percent fat by weight of the total composition. In certain embodiments, the fat composition comprises at least about 80 percent fat by weight of the total composition. The composition preferably is itself a liquid at the temperature at which the composition is applied to the baked dough product. Thus, the fat composition may be a solid at room temperature, provided that it has been heated to above its melting point so that it is applied in the liquid form. Alternatively, the fat composition may be applied as a solid, provided that at least a portion of the composition is converted to a liquid on application to the baked dough product so that the fat is absorbed by the dough to an extent required to modify the texture of a substantial portion of the baked dough product.

A preferred class of fat compositions used in the present invention comprises one or more oils. Preferred oils include, for example, soybean oil, corn oil, cottonseed oil, canola oil, olive oil, sunflower oil, peanut oil, palm oil, coconut oil, palm kernal oil and other vegetable or nut oils. An alternative preferred fat composition comprises fat in the form of a solid at room temperature (i.e. 23° C.). If the fat is a solid, it preferably has a Solid Fat Index of greater than 15 at 21.1° C. Preferred solid fat compositions include, for example, animal fats such as lard, butter, and hydrogenated vegetable oils such as margarine.

Optionally, the fat may comprise additional components, such as flavoring agents, preservatives, emulsifiers, hydrocolloids, viscosity modifiers, colorants, and the like.

Particularly preferred flavoring agents include sweeteners. Sweeteners may be provided either as a natural or artificial sweetener. Preferred sweeteners include but are not limited to lactose, sucrose, fructose, dextrose, maltose, corresponding sugar alcohols, corn syrup, malt and hydrolyzed corn syrup, maltodextrin, and mixtures thereof.

Additional preferred flavoring agents are salt, and pepper; spices and herbs; such as cinnamon, garlic, oregano, rosemary, sage and thyme; malt; yeast; yeast extract; inactivated yeast; vanilla; dairy products, such as cheese and milk; meat products such as chicken, beef, and pork; and commercially available flavorants. The optional flavoring agent preferably is present as greater than about 0.1 percent by weight of the fat, and more preferably is from about 0.5 and about 5.0 percent by weight of the fat.

Preferred emulsifiers include, for example, mono- and di-glycerides of fatty acids, propylene glycol mono- and di-esters of fatty acids, glycerol-lacto esters of fatty acids, ethoxylated mono-glycerides, lecithin, protein, and mixtures thereof. Particularly preferred emulsifiers include mono-glycerides and mixtures of propylene glycol mono- and di-esters of fatty acids, mono-glycerides and lecithin. Preferred hydrocolloids include, for example, starches, gums (e.g. xanthan and guar), cellulose, and carageenan. Preservatives, emulsifiers, and hydrocolloids combined comprise preferably less than about 5 percent by weight of the fat, and each preferably between about 0.1 percent and about 2.5 percent by weight of the fat. Suitable preservatives provide shelf-life extension for the baked product, and include, for example, potassium sorbate, sodium benzoate, sorbic acid, sodium propionate, and sodium diacetate.

After the fat is applied, the baked dough product is stored in a frozen state. For purposes of the present invention, the term “frozen” describes dough products that are maintained at a temperature below the freezing point of water, regardless of whether all ingredients in the dough product are actually in the frozen state. The temperature of the product is less than about 32° F. (0° C.), with the preferred storage temperature being from about −60° F. (−51° C.) to about 20° F. (−7° C.), more preferably from about −40° F. (−40° C.) to about 10° F. (−12° C.), and most preferably from about −10° F. (−23° C.) to about 0° F. (−18° C.). Storage temperature may vary throughout storage time. It is preferred that the designated storage temperature will be maintained for at least about 90% of the time that the product is stored.

In one embodiment, the frozen baked dough product is allowed to thaw prior to reheating. Most preferably, the reheating process is carried out on the frozen baked dough product directly from the frozen state. The latter embodiment provides the highest degree of convenience to the consumer, and is therefore preferred.

The dough may incorporate any of the appropriate ingredients for manufacturing the particular type of dough product that is desired, provided that the resulting unbaked dough product does not stick to dough processing equipment. For example, the dough product may be a bread product (such as breadsticks and filled breadsticks, loaves of bread and the like), roll, and the like. Suitable dough compositions for use in the present invention are well known to those of skill in the baking art. Particularly preferred dough compositions include those specially adapted for use in microwave ovens, such as described in U.S. Pat. No. 5,035,904, the disclosure of which is hereby incorporated by reference. Such specially adapted dough compositions further benefit from incorporation of fat as described herein.

Optionally, the dough product may be a filled dough product. Filling, as used in the present invention, is a non-dough adjuvant flavor component, that is provided either internally as an enclosed filling within the baked dough product, or externally as a topping to the baked dough product.

The filling, if any, may be an uncooked or cooked food product. The filling can have a uniform consistency or a chunky consistency. In preferred embodiments, the filling is a highly viscous liquid, suspension or pseudoliquid, i.e., a flowable mixture of particulates and/or liquid that may not normally be a liquid or a suspension. The material preferably is highly viscous such that it will not flow immediately from the dough product, or, if an internal filling, through any imperfection in a dough covering or out from the ends of seams of the baked dough product when cut and crimped. The filling can be made from any type or types of food ingredients, including savory or sweet ingredients. Examples of savory ingredients include but are not limited to meat, vegetable, and dairy ingredients. Examples of sweet ingredients include but are not limited to fruit or icing ingredients. Both savory and sweet ingredients may further include spices, herbs, flavoring agents, fats, and the like. The filling may further include such ingredients as preservatives and consistency modifiers such as emulsifiers and thickening agents.

Particularly preferred savory fillings are cheese fillings, tomato paste sauces such as Italian sauces, and meat flavored gravies. A highly preferred baked dough product is a cheese filled breadstick. Particularly preferred sweet fillings are vanilla, fruit (such as strawberry, blueberry, peach and so forth), cinnamon or chocolate flavored icings.

### EXAMPLES

### Preparatory Example 1

A dough composition is prepared according to the formula shown in Table 1.

| Ingredient | Amount (weight %) |
|---|---|
| hard wheat flour | 51.49 |
| Water | 21.58 |
| Active dry yeast | 3.41 |
| Albumin | 0.05 |
| Egg yolk solids | 0.08 |
| Distilled monoglycerides | 1.01 |
| Sodium stearyl lactylate (“SSL”) | 0.05 |
| Nonfat milk replacer | 1.11 |
| Yellow color | 0.02 |
| Shortening | 4.02 |
| Salt | 0.67 |
| Sugar | 10 |
| Dextrose | 1.51 |

### Preparatory Example 2

And oil composition was prepared by mixing the following ingredients:

| | amount by |
|---|---|
| Ingredient | weight % |
| Hydrogenated | 50.831 |
| soybean solid | |
| fat | |
| composition | |
| powdered | 36.558 |
| sugar | |
| Coarse | 9.482 |
| dextrose | |
| ground | 3.129 |
| cinnamon | |

### Example 1

The dough of preparatory example 1 was formed into ¾×3×4 breadsticks and baked at 375° F. in a continuous oven for a time sufficient to brown the crust and bake the breadstick product to completion. The breadstick was removed from the oven, and while still hot, the oil composition of preparatory example 2 was applied at a coating weight of 0.25 g/in². The thus coated breadstick was frozen and stored for one week.

### Comparative Example 1

The dough of preparatory example 1 was formed into ¾×3×4 breadsticks and baked at 375° F. in a continuous oven for a time sufficient to brown the crust and bake the breadstick product to completion. The breadstick was frozen without being coated, and stored for one week.

### PRODUCT EVALUATION

### Trained Panel

A 2 by 2 design product evaluation was conducted by a six member panel, comparing textural attributes of products of Example 1 and Comparative Example 1, with an additional variable of serving time. Products of the above examples served immediately after heating in the microwave were compared with product held for 15 minutes after heating in the microwave before serving. Thus, the products evaluated were as follows:

1. No hold time, no oil spray

2. no hold time, oil spray

3. hold 15 minutes, no oil spray

4. hold 15 minutes, oil spray

Texture attributes of the products were rated by the panelists using the “sensory spectrum” method. With this method, panelists are trained to use well-defined standardized methodology for analyzing/evaluating well-defined textural attributes of food. The panelists scored the perceived intensities of these textural attributes of the product based on real food references as absolutes. All attributes are scored on the 0-15 points scale. The data was analyzed using analysis of variance and Tukey means comparisons. The panel was provided with a referenced scale for evaluating specific properties of the product as follows:

| Initial Cohesiveness: | | The degree to which sample deforms |
|---|---|---|
| | | rather than crumbles, cracks, or breaks. |
| | Ref: | Corn Muffin = 1.0 |
| | | Land O Lakes ™ Pasteurized Processed |
| | | American Cheese = 5.0 |
| | | Soft Pretzel = 8.0 |
| | | Raisins = 10.0 |
| | | Starburst ™ Chews = 12.5 |
| Hardness: | The force to bite through with incisors. | |
| | Ref: | Cream Cheese = 1.0 |
| | | Egg White (hard cooked) = 2.5 |
| | | Land O Lakes ™ Pasteurized Processed |
| | | American Cheese |
| | | Cheese = 4.5 |
| | | Olives = 6.0 |
| | | Hebrew National ™ Frank (5 min) = 7.0 |
| | | Peanut = 9.5 |
| | | Carrot = 11.0 |
| | | Lifesaver = 14.5 |
| Moisture Absorption: | | The amount of saliva absorbed by sample |
| | | during chew down. |
| | Ref: | Shoestring Licorice = 0.0 |
| | | Twizzlers Licorice = 3.5 |
| | | Popcorn (Old Dutch ™) = 7.5 |
| | | Potato Chips (Lays ™) = 10.0 |
| | | Pound Cake (Sara Lee ™) = 13.0 |
| | | Saltines = 15.0 |
| Moistness of Mass: | | The degree of moistness of the product in |
| | | the mouth during mastication. |
| | Ref: | Soda Cracker = 1.5 |
| | | Graham Crackers = 6.5 |
| | | Fudge Brownie = 9.0 |
| Residual Mouthcoat: | | The degree of perception of a slick/fatty |
| | | coating on the tongue and other |
| | | mouth surfaces. |
| | | This attribute measures the |
| | | amount of oil left on mouth |
| | | surfaces by feeling the mouth |
| | | surfaces with the tongue. |
| | Reference: saltine cracker = 0.5 | |
| | | Kettle Fried ™ potato chip = 7 |
| | | corn oil = 15. |

TABLE A

| | No Oil | | Oil | |
|---|---|---|---|---|
| Product | | Held 15 | | Held 15 |
| Characteristic | Served Warm | Minutes | Served Warm | Minutes |
| Initial | 7.3 | 7.2 | 7.1 | 7.6 |
| Cohesiveness | | | | |
| Hardness | 5.3 | 5.8 | 5.1 | 5.9 |
| Moisture | 8.5 | 8.8 | 8.7 | 8.3 |
| Absorption | | | | |
| Moistness | 7.8 | 7.4 | 7.9 | 7.6 |
| Residual | 2.6 | 2.1 | 2.6 | 2.5 |
| Mouthcoat | | | | |

The statistical significance of these scores is as follows: Cohesiveness: 0.0229, Hardness: 0.1240, Moisture absorption: 0.1388, Moistness of mass: 0.6416 and Residual Mouthcoat is 0.0126.

Conclusions of Trained Panel Sensory Data:

The Trained Panel identified significant differences in the textural attributes of microwaved product served 15 minutes after heating. Products of the present invention were judged to be more moist and cohesive than non-oil coated products.

Team Panel

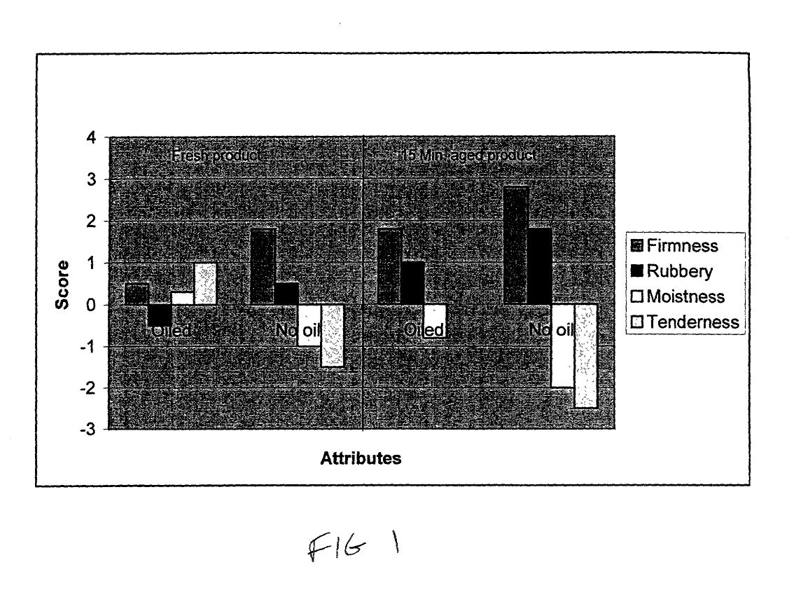

An experienced four member team of food product developers studied the textural attributes of the same product design array as above, evaluating firmness, rubberiness, moistness and tenderness on a +3 to −3 scale. Since firmness and rubberiness are not desirable textural attributes in a breadstick product, a lower relative numerical score is desired for this product in these attribute categories. Since moistness and tenderness are desirable textural attributes in a breadstick product, a higher relative numerical score is desired for this product in these attribute categories. The results of this evaluation are shown in FIG. 1. This experienced team identified that the product provided with an oil coating in accordance with the present invention exhibited superior properties in all categories, particularly when aged for 15 minutes after heating in the microwave.

Microwaved Product Modulus Evaluation

In this Evaluation, dough product samples are prepared, baked, and oil applied as indicated in Example 1 and Comparative Example 1. The product is then frozen for a period of at least 30 minutes. The product is then conditioned for testing by microwave reheating to a temperature of 120° F. and allowed to cool for 15 minutes. The thus conditioned sample is compressed under a blunt pin using an Instron testing device. A 3 mm diameter pin is moved at a crosshead speed of 0.3 mm/sec. in compression of the dough product. The distance of travel of the pin, and the amount of force imparted to the dough product prior to breaking through the crust of the product is measured. The amount of load it takes to break the pin through the crust of the product indicates the firmness of the product.

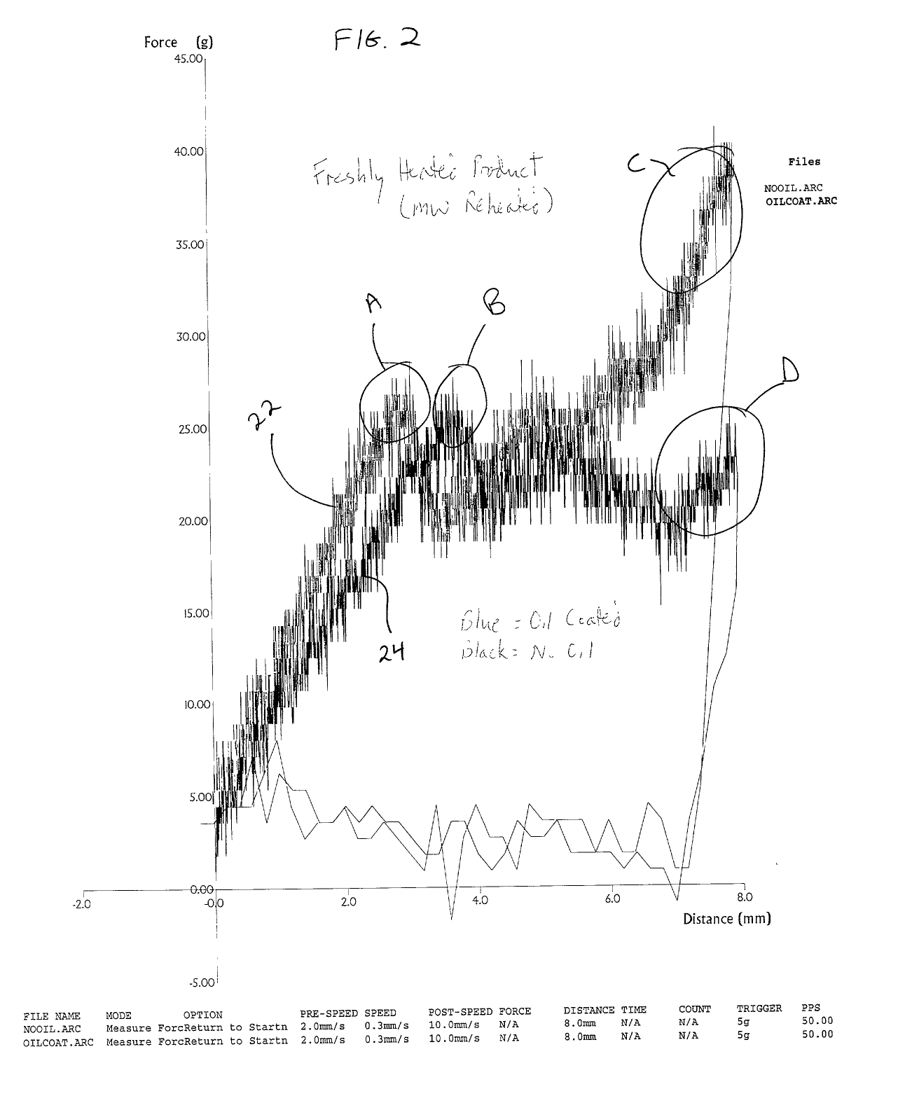

FIG. 2 is a chart showing the Microwaved Product Modulus Evaluation for a product evaluated immediately after microwave heating. In FIG. 2, the distance travel of the pin is reported at the x axis, and the force imparted to the dough product is reported at the y axis. Black line 22 is the force measurement of comparative example 1, the product without oil applied thereto. Blue line 24 is the force measurement of example 1, the product with oil applied thereto. At region A, the pin breaks through the crust of the product of comparative example 1, i.e. at a pin travel distance of about 2.8 mm. At region B, the pin breaks through the crust of the product of example 1, i.e. at a pin travel distance of about 3.8 mm. The amount of force required to continue to progress into the product continues to increase for the product of comparative example 1. See region C. This increasing force reflects a higher degree of toughness of the product. In contrast, the product of example 1 shows no increase in force as the pin continues to progress into the product. See region D.

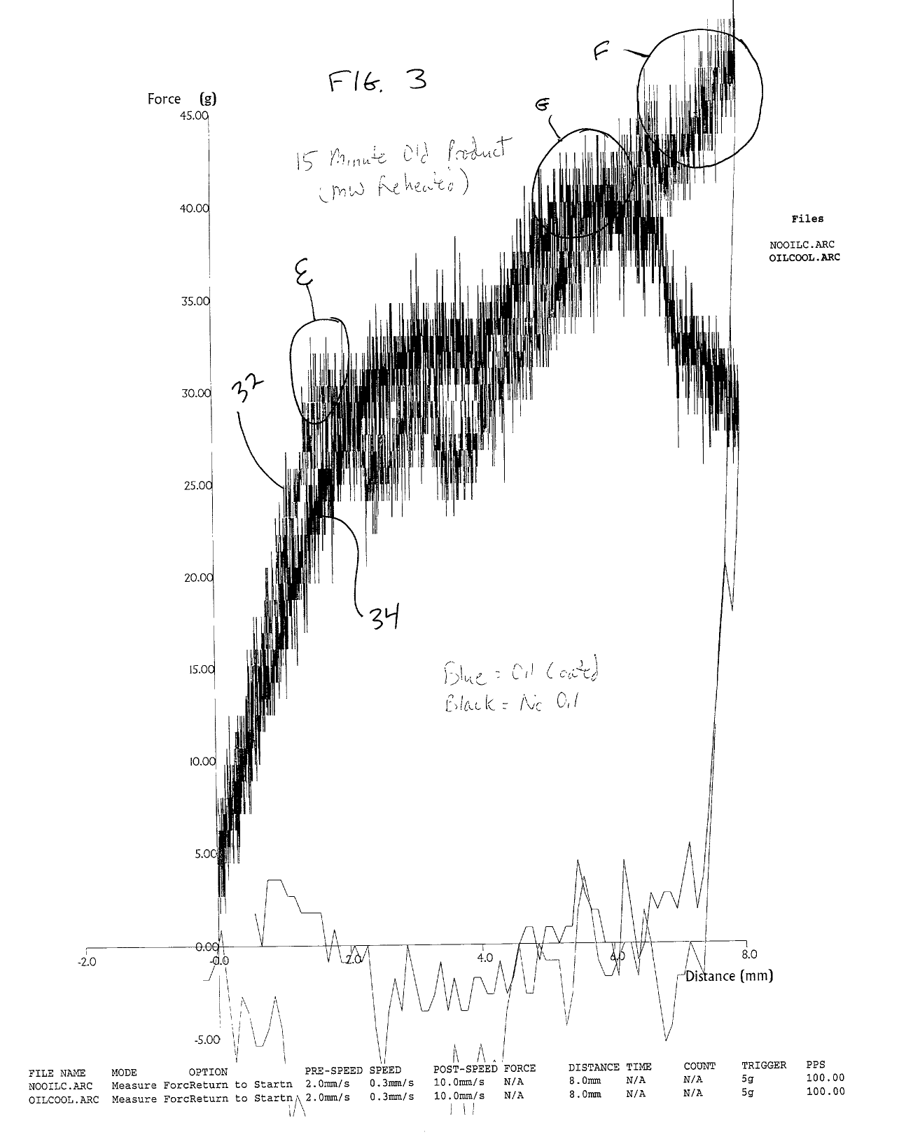

FIG. 3 is a chart showing the Microwaved Product Modulus Evaluation for a product evaluated 15 minutes after microwave heating. As in FIG. 2, the distance travel of the pin is reported at the x axis, and the force imparted to the dough product is reported at the y axis. Black line 32 is the force measurement of comparative example 1, the product without oil applied thereto. Blue line 34 is the force measurement of example 1, the product with oil applied thereto. At region E, the pin breaks through the crust of the product of comparative example 1, i.e. at a pin travel distance of about 2.0 mm. The amount of force required to continue to progress into the product continues to increase for the product of comparative example 1. See region F. In contrast, the pin does not break through the crust of the product of example 1 until region G, i.e. at a pin travel distance of about 5.5 mm.

The elasticity modulus of the product is the slope of the force curve from initial contact of the pin on the product to breaking of the pin through the crust of the product. The elastic modulus reflects the level of pliability or elasticity in the crust. The lower the number, the more the product flexes or stretches. Preferably, the treated baked dough product exhibits an elastic modulus less than 90% of the elastic modulus of the untreated dough product in the Microwaved Product Modulus Evaluation 15 minutes after microwave heating, and more preferably immediately after microwave heating. More preferably, the treated baked dough product exhibits an elastic modulus that is less than 80% of the elastic modulus of the untreated dough product in the Microwaved Product Modulus Evaluation 15 minutes after microwave heating, and more preferably immediately after microwave heating.

In the samples evaluated as shown in the FIG. 2, product tested immediately after microwave heating, the product of Example 1 exhibited an elasticity modulus of 5851.7 g/m, with a peak load of 26.8 grams and a 3.6 mm distance to peak load. In contrast, the product of Comparative Example 1 exhibited an elasticity modulus of 7676.4 g/m m, with a peak load of 26.8 grams and a 3.0 mm distance to peak load. In the samples evaluated as shown in the FIG. 3, product tested 15 minutes after microwave heating, the product of Example 1 exhibited an elasticity modulus of 12084 g/m and a peak load of 33.9 g with a 2.7 mm distance to peak load. In contrast, the product of Comparative Example 1 exhibited an elasticity modulus of 16863.9 g/m with a peak load of 33.08 g and a 1.7 mm distance to peak load

The embodiments described herein are illustrative in nature, and are not intended to limit the scope of the invention. One skilled in the art will recognize that variations are possible without departing from the spirit or scope of the invention.

What is claimed:

1. A process of providing a tender or soft baked dough product, comprising the steps, in order, of
a) preparing an unbaked dough having a surface consistency such that the unbaked dough is processable in automated dough processing equipment;
b) forming a dough product from the unbaked dough;
c) baking the formed dough product;
d) treating the baked dough product by applying a fat thereto under conditions to allow absorption of a sufficient amount of the fat into the dough to noticeably improve textural properties of the baked dough product after microwave reheating as compared to a like product without fat absorbed therein; and
e) storing the treated baked dough product in a frozen state.

2. The process of claim 1, wherein the baked dough product has an elastic modulus less than 90% of the elastic modulus of a like dough product that has not been treated with a fat composition when evaluated in the Microwaved Product Modulus Evaluation fifteen minutes after microwave heating.

3. The process of claim 1, wherein the baked dough product has an elastic modulus less than 80% of the elastic modulus of a like dough product that has not been treated with a fat composition when evaluated in the Microwaved Product Modulus Evaluation fifteen minutes after microwave heating.

4. The process of claim 1, wherein the fat composition has a viscosity of about 1 to about 15,000 centipoise at 195° F.

5. The process of claim 1, wherein the fat composition has a viscosity of about 100 to about 5,000 centipoise at 195° F.

6. The process of claim 4, wherein the fat composition is applied at a coating weight of from about 0.02 to about 0.06 g/in².

7. The process of claim 4, wherein the fat composition is applied at a coating weight of from about 0.03 to about 0.05 g/in².

8. The process of claim 1, wherein the fat composition has a viscosity of from about 2,000 to about 50,000 centipoise at 195° F.

9. The process of claim 1, wherein the fat composition has a viscosity of from about 3,000 to about 20,000 centipoise at 195° F.

10. The process of claim 1, wherein the fat composition contains particulates that help retain the fat on the surface of the baked dough product.

11. The process of claim 8, wherein the fat composition is applied at a coating weight of from about 0.3 to about 0.7 g/in².

12. The process of claim 1, wherein the fat comprises an oil.

13. The process of claim 13, wherein the oil is selected from the group consisting of soybean oil, corn oil, canola oil, olive oil, sunflower oil, and peanut oil.

14. The process of claim 1, wherein the fat is a solid fat composition at 23° C.

15. The process of claim 11, wherein the solid fat composition is selected from the group consisting of butter and margarine.

16. The process of claim 1, wherein the raw dough has a farinograph reading of greater than 850 Brabender units.

17. The process of claim 1, wherein the baked dough product is a product selected from the group consisting of breadstick, bagel, roll, and pastry.

18. The process of claim 1, wherein the baked dough product comprises a filling.

19. The process of claim 1, wherein the baked dough product comprises an enclosed filling.

20. The process of claim 1, wherein the baked dough product is a cheese-filled breadstick.

21. The process of claim 1, wherein the baked dough product is formed by a high speed dough processing equipment capable of processing greater than 500 dough pieces per minute.

22. The process of claim 1, wherein the baked dough product is formed by a high speed dough processing equipment capable of processing greater than 750 dough pieces per minute.

23. The process of claim 1, wherein the baked dough product is formed by a high speed dough processing equipment capable of processing greater than 1000 dough pieces per minute.

24. The product made by the process of claim 1.

25. A frozen baked dough product having a sufficient amount of fat absorbed into the dough to noticeably improve textural properties of the baked dough product after microwave reheating as compared to a like product without fat absorbed therein.

26. The product of claim 25, said product having from about from about 0.02 to about 0.06 g of fat per in² surface area of baked dough product absorbed into the baked dough product.

27. The product of claim 26, said product having less than about 0.02 g/in² of fat on the surface of the product as determined by the Towel Absorbency Test.

28. A method of preparing a product for consumption, comprising
a. providing a product of claim 24,
b. heating the provided product to a desired temperature suitable for consumption by microwave reheating.

29. A method of preparing a product for consumption, comprising
a. providing a product of claim 25,
b. heating the provided product to a desired temperature suitable for consumption by microwave reheating.
